(19) United States
(12) Patent Application Publication
(10) Pub. No.: US 2026/0322230 A1
(43) Pub. Date: Oct. 15, 2026

(54) INTEGRATED COIL ASSEMBLY IN A HAPTIC ACTUATOR MODULE

(71) Applicant: Semtech Corporation, Camarillo, CA (US)

(72) Inventors: Ilya Rosenberg, Sunnyvale, CA (US); Julius Minglin Tsai, San Jose, CA (US); Nandinee Kaushik, San Jose, CA (US)

(21) Appl. No.: 19/643,966

(22) Filed: Apr. 10, 2026

Related U.S. Application Data
(60) Provisional application No. 63/787,108, filed on Apr. 11, 2025.
(60) Provisional application No. 63/862,424, filed on Aug. 12, 2025.

(51) Int. Cl. H02K 33/18; H02K 15/40

(52) U.S. Cl. CPC H02K 33/18; H02K 15/40

(57) ABSTRACT

An integrated coil assembly in a haptic actuator module is disclosed. Herein, the haptic actuator module includes multiple permanent magnets and an integrated coil assembly that can be configured to collectively generate a haptic force in a desired direction (e.g., vertical or horizontal) when the integrated coil assembly is energized. The integrated coil assembly can be assembled based on a variety of embodiments to achieve a reduced z-height and complexity. As a result, it is possible to manufacture and/or customize the haptic actuator module (e.g., size, shape, impedance, drive voltage, etc.) with improved output efficiency and reduced manufacturing cost for a greater market penetration.

### RELATED APPLICATIONS

This application claims the benefit of U.S. provisional patent applications Ser. No. 63/787,108 filed Apr. 11, 2025 and Ser. No. 63/862,424 filed Aug. 12, 2025, the disclosures of which are incorporated herein by reference in their entireties.

### FIELD OF THE DISCLOSURE

The technology of the disclosure relates generally to an integrated coil assembly in a haptic actuator module (e.g., a direct drive actuator module) that can provide a haptic response in an electronic device.

### BACKGROUND

Modern user interfaces in electronic devices (e.g., smartphones, tablets, laptop computers, game controllers, automobile infotainment systems, etc.) are transitioning from mechanical buttons toward touch-based user interfaces. The prevalence of the touch-based user interfaces is driven in part by advancement in touchscreens, strain-based force sensors, and haptic technologies, whereby user interactions with a touch surface can be emulated by a combination of touch sensing, force sensing, and haptic output.

The haptic output is typically generated by means of a haptic actuator. Conventional haptic actuators like eccentric rotating mass (ERM) actuators, linear resonant actuators (LRAs), and piezo actuators all have noticeable shortcomings that make it difficult for integration into most applications. Specifically, the ERM actuator and LRA are often bulky, expensive, and power hungry. Moreover, the haptic output generated by the ERM actuator and the LRA can create a buzzy sensation that may be noisy and unpleasant to an end user. Furthermore, both types of actuators typically have a high-Q factor, which can produce a strong response only within a narrow band of frequencies but are unable to reproduce more complex waveforms with a wide range of frequencies. The piezo actuator, on the other hand, is more difficult to drive electrically due to ceramic-based construction. In addition, the piezo actuator also tends to have relatively high resonant frequencies and is unable to produce low frequency vibrations.

A promising alternative to the conventional haptic actuators is a direct drive actuator (DDA), which can create a better haptic effect by pushing directly on the touch surface. Unfortunately, a compact and low-cost DDA is not readily available due to limitations in available designs. As such, it is desired to create a compact and low-cost haptic actuator module that is less buzzy and can reproduce a strong haptic output across a wide range of desired frequencies. Moreover, the haptic actuator module should be made as compact as possible to accommodate a variety of electronic devices and/or applications.

### SUMMARY

Embodiments of the disclosure relate to an integrated coil assembly in a haptic actuator module. Herein, the haptic actuator module includes multiple permanent magnets and an integrated coil assembly that can be configured to collectively generate a haptic force in a desired direction (e.g., vertical or horizontal) when the integrated coil assembly is energized. The integrated coil assembly can be assembled based on a variety of embodiments to achieve a reduced z-height and complexity. As a result, it is possible to manufacture and/or customize the haptic actuator module (e.g., size, shape, impedance, drive voltage, etc.) with improved output efficiency and reduced manufacturing cost for a greater market penetration.

In one aspect, a haptic actuator module is provided. The haptic actuator module includes an integrated coil assembly. The integrated coil assembly includes a top spool piece and a bottom spool piece. The top spool piece and the bottom spool piece are bonded together. The integrated coil assembly also includes an electromagnetic coil. The electromagnetic coil is disposed between the top spool piece and the bottom spool piece. The haptic actuator module also includes a housing. The housing has a central opening configured to receive the integrated coil assembly to thereby reduce an overall z-height of the haptic actuator module. The haptic actuator module also includes a pair of permanent magnets. The pair of permanent magnets are disposed on opposite lateral sides of the central opening and coplanar with the electromagnetic coil such that the pair of permanent magnets can interact with the electromagnetic coil to generate an actuation force in a desired direction when the electromagnetic coil is energized.

In another aspect, a wireless device is provided. The wireless device includes a haptic actuator module. The haptic actuator module includes an integrated coil assembly. The integrated coil assembly includes a top spool piece and a bottom spool piece. The top spool piece and the bottom spool piece are bonded together. The integrated coil assembly also includes an electromagnetic coil. The electromagnetic coil is disposed between the top spool piece and the bottom spool piece. The haptic actuator module also includes a housing. The housing has a central opening configured to receive the integrated coil assembly to thereby reduce an overall z-height of the haptic actuator module. The haptic actuator module also includes a pair of permanent magnets. The pair of permanent magnets are disposed on opposite lateral sides of the central opening and coplanar with the electromagnetic coil such that the pair of permanent magnets can interact with the electromagnetic coil to generate an actuation force in a desired direction when the electromagnetic coil is energized.

In another aspect, a method for assembling a haptic actuation device is provided. The method includes preassembling a haptic actuator module. The method also includes forming a slot on a supporting structure with a shape corresponding to that of the haptic actuator module. The method also includes disposing the haptic actuator module into the slot and adhering a housing of the haptic actuator module to the supporting structure. The method also includes adhering the haptic actuator module to a touch surface.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of an exemplary haptic actuation device wherein a haptic actuator module can be provided between a top surface and a supporting structure according to various embodiments of the present disclosure to generate an actuation force in a desired direction;

FIGS. 2A-2D are schematic diagrams illustrating operating principles of the haptic actuator module in FIG. 1 configured according to an in-plane configuration of the present disclosure;

FIGS. 3A-3E are schematic diagrams providing various views of the haptic actuator module in FIG. 1, assembled based on an embodiment of the present disclosure and configured to generate the actuation force in accordance with the operating principles illustrated in FIGS. 2A-2D;

FIGS. 4A-4E are schematic diagrams illustrating various views of an integrated coil assembly in the haptic actuator module illustrated in FIGS. 3A-3E;

FIGS. 5A-5B are schematic diagrams providing exemplary top and bottom views of a flex tail in the haptic actuator module illustrated in FIGS. 3A-3E;

FIG. 6 is a schematic diagram of an exemplary communication device wherein the haptic actuation device of FIG. 1 can be provided; and

FIG. 7 is a flowchart of an exemplary process for assembling the haptic actuation device of FIG. 1.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term "and/or" includes any and all combinations of one or more of the associated listed items.

It will be understood that when an element such as a layer, region, or substrate is referred to as being "on" or extending "onto" another element, it can be directly on or extend directly onto the other element or intervening elements may also be present. In contrast, when an element is referred to as being "directly on" or extending "directly onto" another element, there are no intervening elements present. Likewise, it will be understood that when an element such as a layer, region, or substrate is referred to as being "over" or extending "over" another element, it can be directly over or extend directly over the other element or intervening elements may also be present. In contrast, when an element is referred to as being "directly over" or extending "directly over" another element, there are no intervening elements present. It will also be understood that when an element is referred to as being "connected" or "coupled" to another element, it can be directly connected or coupled to the other element or intervening elements may be present. In contrast, when an element is referred to as being "directly connected" or "directly coupled" to another element, there are no intervening elements present.

Relative terms such as "below" or "above" or "upper" or "lower" or "horizontal" or "vertical" may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms "a," "an," and "the" are intended to include the plural forms as well, unless the context clearly indicates otherwise. It will be further understood that the terms "comprises," "comprising," "includes," and/or "including" when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments of the disclosure relate to an integrated coil assembly in a haptic actuator module. Herein, the haptic actuator module includes multiple permanent magnets and an integrated coil assembly that can be configured to collectively generate a haptic force in a desired direction (e.g., vertical or horizontal) when the integrated coil assembly is energized. The integrated coil assembly can be assembled based on a variety of embodiments to achieve a reduced z-height and complexity. As a result, it is possible to manufacture and/or customize the haptic actuator module (e.g., size, shape, impedance, drive voltage, etc.) with improved output efficiency and reduced manufacturing cost for a greater market penetration.

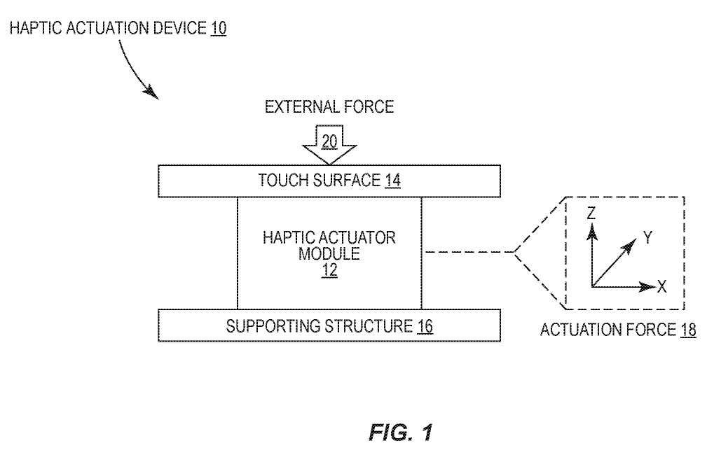

FIG. 1 is a schematic diagram of an exemplary haptic actuation device 10 wherein a haptic actuator module 12 can be provided with a touch surface 14 (e.g., a touchscreen) and a supporting structure 16 (e.g., a bracket or a midframe) according to various embodiments of the present disclosure to generate an actuation force 18 in a desired direction. As further described below, the haptic actuator module 12 can be configured to generate the actuation force 18 along an x-axis, y-axis, or z-axis in a three-dimensional Cartesian coordinate system, depending on specific electronic devices and/or applications to be supported. In one example, the haptic actuator module 12 can be configured to generate the actuation force 18 perpendicular to the touch surface 14 to thereby create a displacement in the touch surface 14 (a.k.a. z-axis) when an external force 20 (e.g., a finger press) is applied onto the touch surface 14. In another example, the haptic actuator module 12 may also be configured to generate the actuation force 18 in parallel to the touch surface 14 to thereby create a displacement along the x-axis or the y-axis.

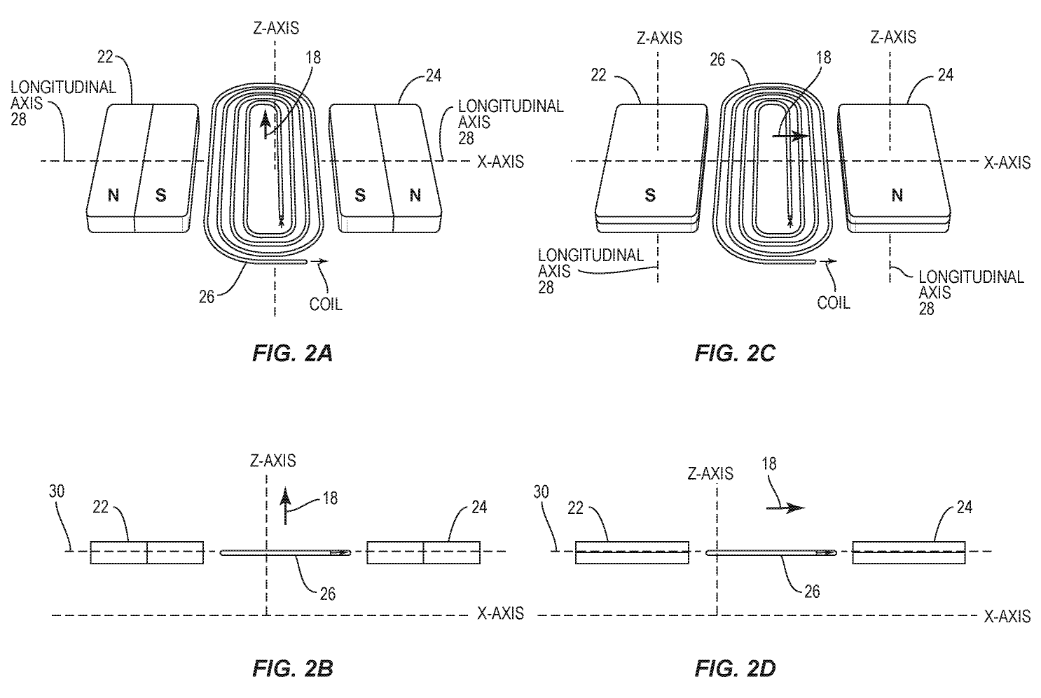

FIGS. 2A-2D are schematic diagrams illustrating operating principles of the haptic actuator module 12 in FIG. 1 when the haptic actuator module 12 is configured according to an in-plane configuration. Specifically, FIGS. 2A and 2B illustrate how the haptic actuator module 12 can be configured to generate the actuation force 18 along the z-axis, whereas FIGS. 2C and 2D illustrate how the haptic actuator module 12 can be configured to generate the actuation force 18 along the x-axis. Common elements between FIGS. 1 and 2A-2D are shown therein with common element numbers and will not be re-described herein.

With reference to FIG. 2A, the haptic actuator module 12 configured based on the in-plane configuration includes a pair of permanent magnets 22, 24 and an electromagnetic coil 26 disposed between the permanent magnets 22 and 24. Although the electromagnetic coil 26 is shown herein as a rectangular shaped coil, it should be appreciated that the electromagnetic coil 26 can also be formed in other suitable shapes, such as circular shaped, square shaped, and so on.

When provided in the haptic actuation device 10, each of the permanent magnets 22 and 24 is oriented with a longitudinal axis 28 in parallel to the touch surface 14 and the supporting structure 16. The south pole (S) of each of the permanent magnets 22 and 24 is facing toward the electromagnetic coil 26, whereas the north pole (N) of each of the permanent magnets 22 and 24 is facing away from the electromagnetic coil 26. The electromagnetic coil 26 is energized when an electrical current I_{COIL} flows counterclockwise through the electromagnetic coil 26. Accordingly, the electromagnetic coil 26 will interact with the permanent magnets 22 and 24 to thereby cause the haptic actuator module 12 to generate the actuation force 18 toward the touch surface 14 along the z-axis, and perpendicular to the longitudinal axis 28. In an embodiment, the electromagnetic coil 26 can be wound more tightly and/or configured with multiple windings to help further boost the actuation force 18.

FIG. 2B illustrates a cross-section view of the haptic actuator module 12 of FIG. 2A configured to generate the actuation force 18 along the z-axis. As the name “in-plane” suggests, the electromagnetic coil 26 is positioned in coplanarity with the permanent magnets 22 and 24. Studies have shown that the haptic actuator module 12 will generate a strongest one of the actuation force 18 when the electromagnetic coil 26 is disposed along a center line 30 of the permanent magnets 22 and 24.

With reference to FIGS. 2C and 2D, when provided in the haptic actuation device 10 to generate the actuation force 18 along the x-axis, the permanent magnets 22 and 24 are each oriented with the longitudinal axis 28 perpendicular to the touch surface 14 and the supporting structure 16. In addition, the permanent magnets 22 and 24 are configured to have opposing polarities. As illustrated in FIG. 2C, the permanent magnet 22 has the south pole (S) facing north, whereas the permanent magnet 24 has the north pole (N) facing north. The electromagnetic coil 26 is energized when the electrical current I_{COIL} flows counterclockwise through the electromagnetic coil 26. Accordingly, the electromagnetic coil 26 will interact with the permanent magnets 22 and 24 to thereby cause the haptic actuator module 12 to generate the actuation force 18 in parallel to the touch surface 14 along the x-axis, and perpendicular to the longitudinal axis 28. Herein, the electromagnetic coil 26 can be wound more tightly and/or configured with multiple windings to help further boost the actuation force 18.

FIG. 2D illustrates a cross-section view of the haptic actuator module 12 of FIG. 2C configured to generate the actuation force 18 along the x-axis. Herein, the electromagnetic coil 26 is also disposed along the center line 30 of the permanent magnets 22 and 24 to help boost the actuation force 18 to the highest degree.

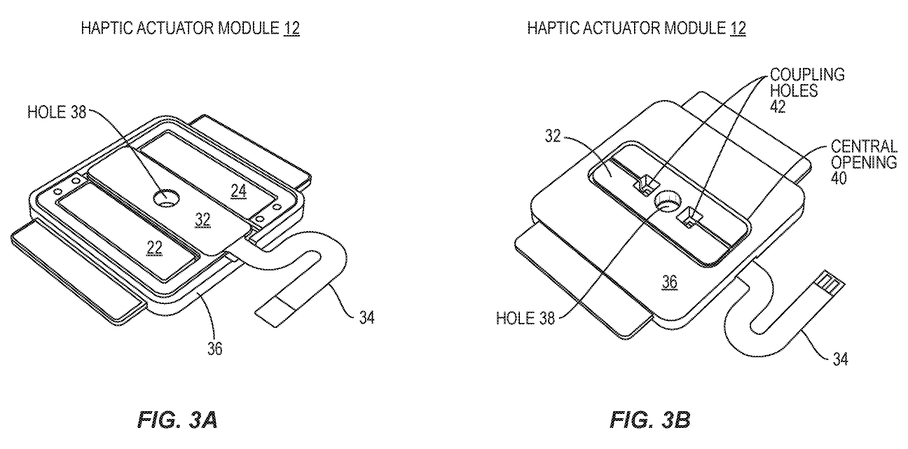

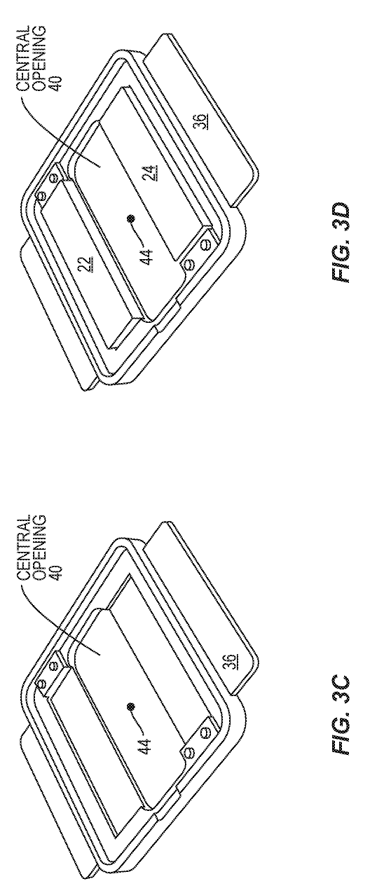

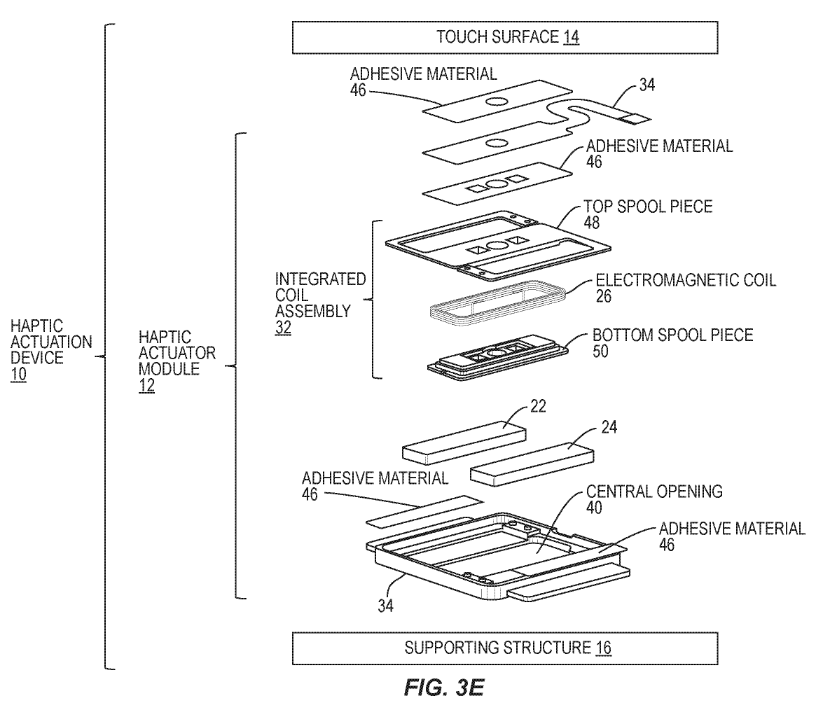

FIGS. 3A-3E are schematic diagrams providing various views of the haptic actuator module 12 in FIG. 1 assembled based on an embodiment of the present disclosure and configured to generate the actuation force 18 in accordance with the operating principles illustrated in FIGS. 2A-2D. Common elements between FIGS. 1, 2A-2D, and 3A-3E are shown therein with common element numbers and will not be re-described herein.

FIG. 3A is a schematic diagram providing an exemplary top view of the haptic actuator module 12 that has been preassembled and is ready to be provided in the haptic actuation device 10 of FIG. 1 to function as the haptic actuator module 12. In order to use the haptic actuator module 12 in various types of applications, the haptic actuator module 12 needs to be as compact as possible. As an example, the haptic actuator module 12 illustrated herein can be assembled with an area of 25×25 mm² and a thickness of 2 mm.

Herein, the haptic actuator module 12 includes the permanent magnets 22 and 24, an integrated coil assembly 32 incorporating the electromagnetic coil 25 in FIGS. 2A-2D, a flex tail 34 for providing the coil current I_{COIL} to the electromagnetic coil 26, and a housing 36 whereto the permanent magnets 22 and 24 and the integrated coil assembly 32 are adhered.

In some embodiments, the housing 36 may be made of plastic or of metal, or a combination thereof. In other embodiments, the housing 36 may also be made with ferrous metal such that the housing 36 can also act as a magnetic shield or magnetic yoke to shield the haptic actuation device 10 from magnetic fields and improve performance of the permanent magnets 22 and 24.

The permanent magnets 22 and 24 are preferably Neodynium magnets with a grade such as N42 or N52 to maximize output. Heat tolerant grades can also be used to prevent magnet degradation in hot storage or operating environments.

A hole 38 is provided in a center of the haptic actuator module 12. The hole 38 may be used for multiple different purposes. In one example, the hole 38 can be used to fasten the integrated coil assembly 32 onto the supporting structure 16 when the haptic actuator module 12 is provided in the haptic actuation device 10. In another example, the hole 38 may be used for coil winding and handling when the integrated coil assembly 32 is assembled in an automated manufacturing process.

FIG. 3B is a schematic diagram providing an exemplary bottom view of the haptic actuator module 12. Herein, the housing 36 is formed with a central opening 40 configured to receive the integrated coil assembly 32. In a non-limiting example, the central opening 40 is so formed to provide approximately one-half (½) millimeter clearance along each side of the integrated coil assembly 32 such that the integrated coil assembly 32 can be fully received within the central opening 40. By disposing the integrated coil assembly 32 in the central opening 40, as opposed to sitting on top of the housing 36, the z-height of the haptic actuator module 12 can be reduced.

In an embodiment, the integrated coil assembly 32 can also include one or more coupling holes 42. The coupling holes 42 may be used to electrically couple the electromagnetic coil 26 to the flex tail 34.

FIG. 3C is a schematic diagram providing an exemplary close-up view of the housing 36 in FIG. 3B. As illustrated herein, the central opening 40 is formed around a center point 44 of the housing 36. In an embodiment, the central opening 40 is dimensioned larger than the integrated coil assembly 32 to permit lateral movement (e.g., up and down) of the integrated coil assembly 32 within the central opening 40.

In addition, the housing 36 may be so designed to ensure accurate alignment of the permanent magnets 22 and 24 to prevent potential interference with the integrated coil assembly 32. The housing 36 may also contain pins for aligning the integrated coil assembly 32 when the haptic actuator module 12 is assembled.

FIG. 3D is a schematic diagram providing an exemplary close-up view of the housing 36 after the permanent magnets 22 and 24 are disposed therein. As illustrated, the permanent magnets 22 and 24 are disposed on opposite lateral sides of the central opening 40. In an embodiment, the permanent magnets 22 and 24 can be adhered to the housing 36 with such strong adhesive as epoxy or cyanoacrylate. Alternatively, it may also be possible to adhere the permanent magnets 22 and 24 to the housing 36 using pressure sensitive adhesive (PSA).

FIG. 3E provides an exploded view of the haptic actuator module 12 assembled based on an embodiment of the present disclosure. Herein, the permanent magnets 22 and 24 are adhered to the housing 36 using an adhesive material 46, which will also be used to adhere the housing 36 to the supporting structure 16 in the haptic actuation device 10.

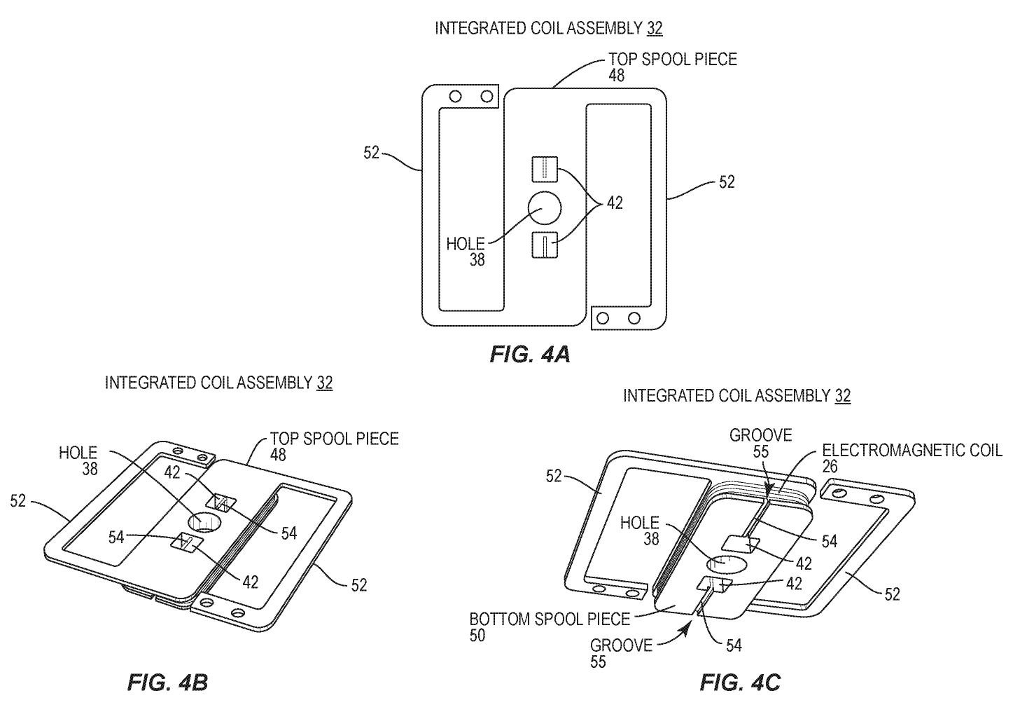

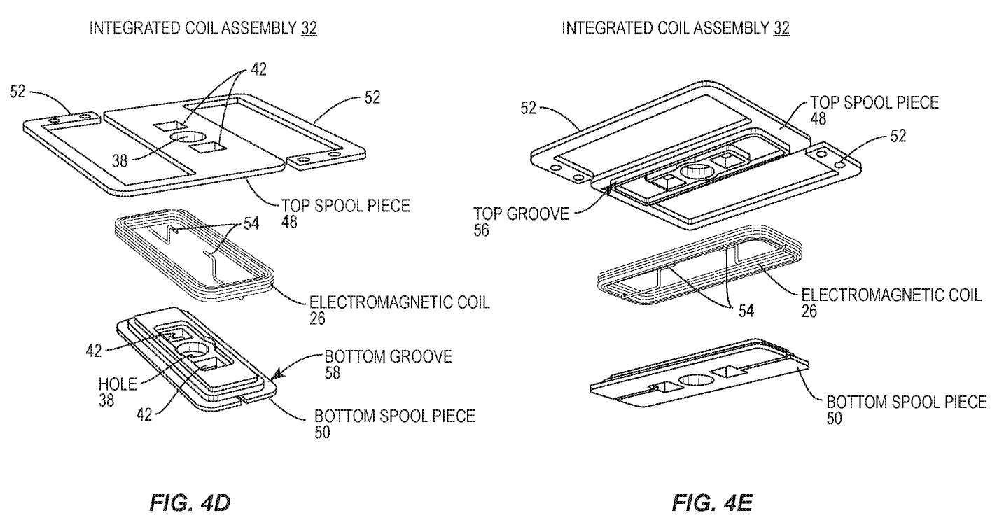

The integrated coil assembly 32 is disposed inside of and configured to be fully received by the central opening 40. As further described in FIGS. 4A-4E, the integrated coil assembly 32 can be preassembled with a top spool piece 48, a bottom spool piece 50, and the electromagnetic coil 26 disposed in between. Herein, the integrated coil assembly 32 is also adhered to the supporting structure 16 in the haptic actuation device 10 using the adhesive material 46. The integrated coil assembly 32 is adhered to the flex tail 34 by the adhesive material 46, which will be further adhered to the touch surface 14 by the adhesive material 46.

FIGS. 4A-4E are schematic diagrams illustrating various views of the integrated coil assembly 32 in the haptic actuator module 12 illustrated in FIGS. 3A-3E. Common elements between FIGS. 1, 2A-2D, 3A-3E, and 4A-4E are shown therein with common element numbers and will not be re-described herein.

FIG. 4A provides an overhead view of the integrated coil assembly 32. As can be seen herein, the integrated coil assembly 32 includes at least one spring 52, which can be made with identical or different material from rest of the top spool piece 48. In an embodiment, the spring 52 is configured to retain and properly center the electromagnetic coil 26 (not shown) in the integrated coil assembly 32. The spring 52 is designed to be large and soft (e.g., low k-constant) to allow for low a resonant frequency and quality factor (Q-factor) such that the haptic actuator module 12 can operate with a wide range of frequencies.

The spring 52 may be manufactured as part of the top spool piece 48 with a simple injection molding process to help reduce complexity of the top spool piece 48. Nevertheless, it should be appreciated that the spring 52 may also be made of a separate component (e.g., a thin plastic piece or a thin spring-steel piece) and attached to the top spool piece 48.

FIG. 4B illustrates an isometric overhead view of the integrated coil assembly 32. As illustrated herein, one or more coupling ends 54 of the electromagnetic coil 26 are routed into the coupling holes 42.

FIG. 4C illustrates an isometric bottom view of the integrated coil assembly 32. In an embodiment, a pair of grooves 55 are formed on the bottom spool piece 50 to route the coupling ends 54 of the electromagnetic coil 26 into the coupling holes 42. Understandably, routing the coupling ends 54 through the grooves 55 can also help reduce the z-height of the integrated coil assembly 32.

FIG. 4D illustrates an exploded overhead view of the integrated coil assembly 32 and FIG. 4E illustrates an exploded bottom view of the integrated coil assembly 32. In an embodiment, a top groove 56 and a bottom groove 58 may be formed on a lower side of the top spool piece 48 and an upper side of the bottom spool piece 50, respectively, to help interlock the top spool piece 48 with the bottom spool piece 50 precisely and provide additional stiffness. During assembly, the top spool piece 48 and the bottom spool piece 50 may first be glued together using such standard processes as injection molding or three-dimensional (3D) printing, and the electromagnetic coil 26 is wound into the integrated coil assembly 32 thereafter. Understandably, it is also possible to manufacture the integrated coil assembly 32 using more complex tooling and/or post-machining processes.

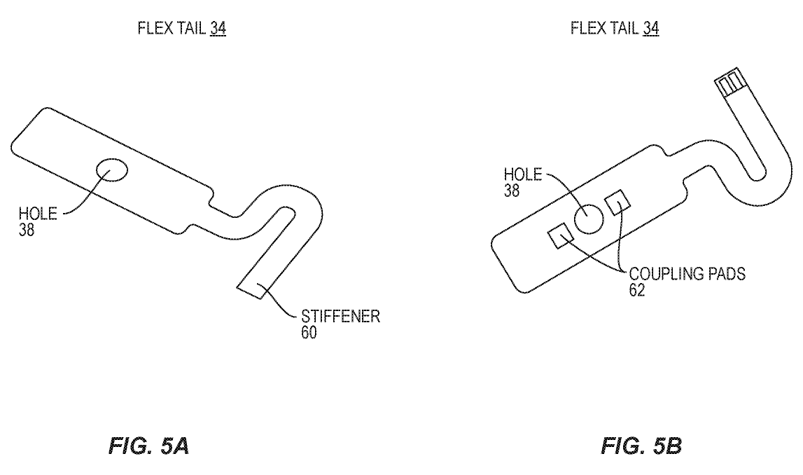

FIGS. 5A-5B are schematic diagrams providing exemplary top and bottom views of the flex tail 34 in the haptic actuator module 12 illustrated in FIGS. 3A-3E. Common elements between FIGS. 3A-3E, 4A-4E, and 5A-5B are shown therein with common element numbers and will not be re-described herein.

With reference to FIG. 5A, the flex tail 34 includes a stiffener 60 configured to ensure a proper electrical connection to a zero-insertion force (ZIF) connector.

With reference to FIG. 5B, the flex tail 34 can be configured to include one or more coupling pads 62. The coupling pads 62 are aligned with the coupling holes 42, respectively. The coupling pads 62 can be soldered with the coupling ends 54 in the coupling holes 42 to thereby provide seamless connection to external circuitries.

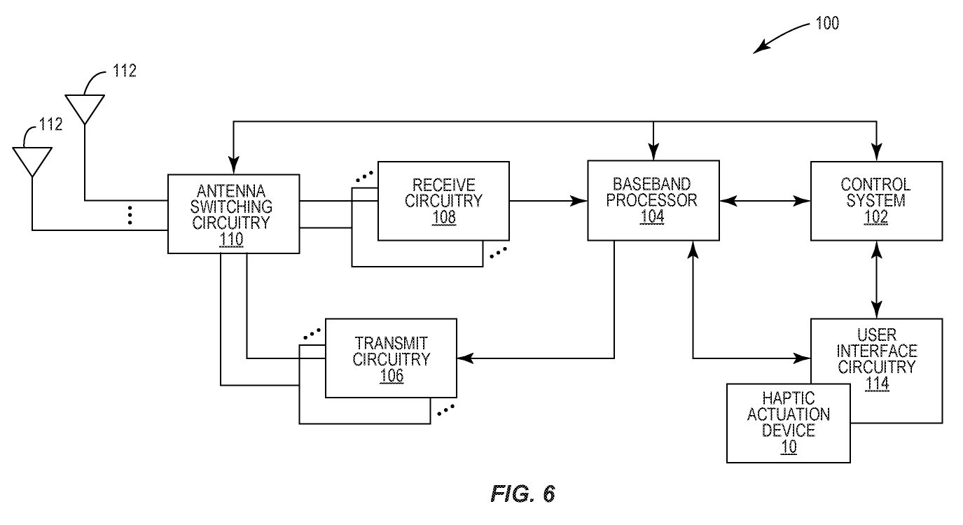

In an embodiment, the haptic actuation device 10 of FIG. 1 can be provided in various types of touch-based electronic devices, including but not limited to a touch-based wireless device. In this regard, FIG. 6 is a schematic diagram of an exemplary communication device 100 wherein the haptic actuation device 10 of FIG. 1 can be provided.

Herein, the communication device 100 can be any type of communication device, such as a mobile terminal, smart watch, tablet, computer, navigation device, access point, base station (e.g., eNB, gNB, etc.), and any other type of wireless communication device that support wireless communications, such as cellular, wireless local area network (WLAN), Bluetooth, Ultra-wideband (UWB), and near field communications. The communication device 100 will generally include a control system 102, a baseband processor 104, transmit circuitry 106, receive circuitry 108, antenna switching circuitry 110, multiple antennas 112, and user interface circuitry 114. In an embodiment, the haptic actuation device 10 of FIG. 1 can be provided in the user interface circuitry 114.

In a non-limiting example, the control system 102 can be a field-programmable gate array (FPGA), as an example. In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using an analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission, and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art.

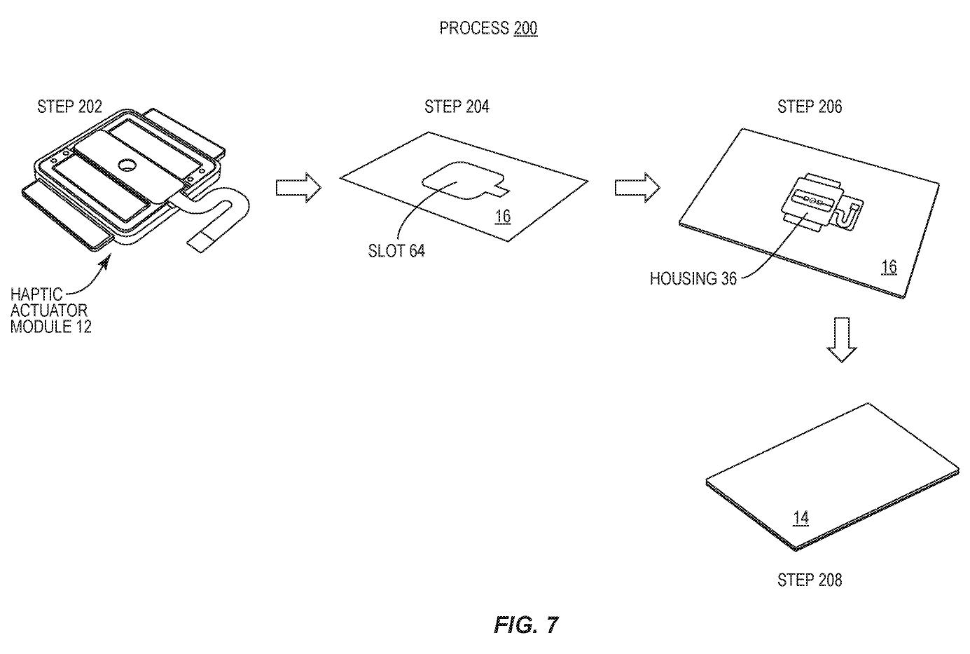

In an embodiment, the haptic actuation device 10 of FIG. 1 can be assembled in accordance with a process. In this regard, FIG. 7 is a flowchart of an exemplary process 200 for assembling the haptic actuation device 10 of FIG. 1.

The process 200 includes preassembling the haptic actuator module 12 (step 202). Herein, the integrated coil assembly 32 can be preassembled as described in FIGS. 4A-4E and then integrated into the haptic actuator module 12 as described in FIGS. 3A-3E.

The process 200 also includes forming a slot 64 on the supporting structure 16 with a shape corresponding to that of the haptic actuator module 12 (step 204). The process 200 also includes disposing the haptic actuator module 12 into the slot 64 and adhering the housing 36 of the haptic actuator module 12 to the supporting structure 16 (step 206). The process 200 also includes adhering the haptic actuator module 12 to the touch surface 14 (step 208).

Those skilled in the art will recognize improvements and modifications to the preferred embodiments of the present disclosure. All such improvements and modifications are considered within the scope of the concepts disclosed herein and the claims that follow.

What is claimed is:

1. A haptic actuator module comprising:
an integrated coil assembly comprising:
a top spool piece and a bottom spool piece bonded together; and
an electromagnetic coil disposed between the top spool piece and the bottom spool piece;
a housing having a central opening configured to receive the integrated coil assembly to thereby reduce an overall z-height of the haptic actuator module; and
a pair of permanent magnets disposed on opposite lateral sides of the central opening and coplanar with the electromagnetic coil such that the pair of permanent magnets can interact with the electromagnetic coil to generate an actuation force in a desired direction when the electromagnetic coil is energized.

2. The haptic actuator module of claim 1, wherein the electromagnetic coil comprises a plurality of windings.

3. The haptic actuator module of claim 1, wherein the central opening is dimensioned larger than the integrated coil assembly to permit lateral movement of the integrated coil assembly within the central opening.

4. The haptic actuator module of claim 1, wherein the integrated coil assembly further comprises at least one spring integrated with the top spool piece and configured to retain and center the electromagnetic coil in the integrated coil assembly.

5. The haptic actuator module of claim 4, wherein the at least one spring is made of a same material as the top spool piece.

6. The haptic actuator module of claim 4, wherein the at least one spring is made of a different material from the top spool piece.

7. The haptic actuator module of claim 1, wherein:
the top spool piece comprises a top groove on a lower side of the top spool piece; and
the bottom spool piece comprises a bottom groove on an upper side of the bottom spool piece to interlock the bottom spool piece with the top spool piece.

8. A wireless device comprising a haptic actuator module, the haptic actuator module comprises:
an integrated coil assembly comprising:
a top spool piece and a bottom spool piece bonded together; and
an electromagnetic coil disposed between the top spool piece and the bottom spool piece;
a housing having a central opening configured to receive the integrated coil assembly to thereby reduce an overall z-height of the haptic actuator module; and
a pair of permanent magnets disposed on opposite lateral sides of the central opening and coplanar with the electromagnetic coil such that the pair of permanent magnets can interact with the electromagnetic coil to generate an actuation force in a desired direction when the electromagnetic coil is energized.

9. The wireless device of claim 8, wherein the electromagnetic coil comprises a plurality of windings.

10. The wireless device of claim 8, wherein the central opening is dimensioned larger than the integrated coil assembly to permit lateral movement of the integrated coil assembly within the central opening.

11. The wireless device of claim 8, wherein the integrated coil assembly further comprises at least one spring integrated with the top spool piece and configured to retain and center the electromagnetic coil in the integrated coil assembly.

12. The wireless device of claim 11, wherein the at least one spring is made of a same material as the top spool piece.

13. The wireless device of claim 11, wherein the at least one spring is made of a different material from the top spool piece.

14. The wireless device of claim 8, wherein:
the top spool piece comprises a top groove on a lower side of the top spool piece; and
the bottom spool piece comprises a bottom groove on an upper side of the bottom spool piece to interlock the bottom spool piece with the top spool piece.

15. A method for assembling a haptic actuation device comprising:
preassembling a haptic actuator module;
forming a slot on a supporting structure with a shape corresponding to that of the haptic actuator module;
disposing the haptic actuator module into the slot and adhering a housing of the haptic actuator module to the supporting structure; and
adhering the haptic actuator module to a touch surface.

16. The method of claim 15, wherein preassembling the haptic actuator module comprises:
assembling an integrated coil assembly comprising:
a top spool piece and a bottom spool piece bonded together; and
an electromagnetic coil disposed between the top spool piece and the bottom spool piece;
forming a central opening in the housing to receive the integrated coil assembly to thereby reduce an overall z-height of the haptic actuator module; and
disposing a pair of permanent magnets on opposite lateral sides of the central opening and coplanar with the electromagnetic coil such that the pair of permanent magnets can interact with the electromagnetic coil to generate an actuation force in a desired direction when the electromagnetic coil is energized.

17. The method of claim 16, further comprising forming the electromagnetic coil with a plurality of windings.

18. The method of claim 16, further comprising dimensioning the central opening to be dimensioned larger than the integrated coil assembly to permit lateral movement of the integrated coil assembly within the central opening.

19. The method of claim 16, further comprising integrating one or more springs with the top spool piece to thereby retain and center the electromagnetic coil in the integrated coil assembly.

20. The method of claim 16, further comprising interlocking the top spool piece with the bottom spool piece via a top groove provided on a lower side of the top spool piece and a bottom groove provided on an upper side of the bottom spool piece.
